(19) United States
(12) Patent Application Publication
(10) Pub. No.: US 2002/0009121 A1
(43) Pub. Date: Jan. 24, 2002

(54) COOKING UTENSIL WITH TEMPERATURE SENSOR

(76) Inventor: HENRY YIU-MAN SIU, HONG KONG (HK)

Correspondence Address: Peter C. Knops, Lathrop & Gage, 2345 Grand Blvd, Suite 2800, Kansas City, MO, 64018, US

(21) Appl. No.: 09/307,802

(22) Filed: May 10, 1999

(51) Int. Cl. G01K 1/14; G01K 13/00; G08B 17/00; A23L 1/00; A47J 9/00

(52) U.S. Cl. 374/155; 374/141; 99/342; 340/584; 340/586

(57) ABSTRACT

This invention provides a cooking utensil, particularly in the form of a fork. A temperature sensor is provided on a tine of the fork to provide information to a processing unit within the handle. The processing unit contains information on the desired temperatures for specific levels of cooking for a variety of products. A user may select a particular product being cooked and a desired level of cooking so that the processing unit may compare results from the temperature sensor with the desired predetermined level. The processing unit may then output a result to a display and/or alarm function to indicate when the desired level of cooking has achieved.

### FILED OF THE INVENTION

This invention relates to cooking utensils with temperature sensors and, in particular, although not necessarily solely, a cooking utensil in the form of a carving or barbecue fork.

### BACKGROUND OF THE PRIOR ART

A variety of cooking utensils have been provided in the past Additionally, temperature sensors for cooking have been provided which typically provide a probe for insertion into the food and an analogue temperature sensor to provide a readout of the internal temperature of the food.

Although such temperature probes can provide an indication of the internal temperature, they generally do not provide much in the way of guidance on the correct internal temperature for the type of cooking being conducted. For example, not only does the temperature indicate the degree to which the article has been cooked but also this temperature is variable with different products. An analogue sensor with a simple readout is unable to provide any guidance on the correct internal temperature for different degrees of cooking such as rare, medium or well done on different products such as the meat types beef, veal, lamb, etc.

Another problem with conventional temperature probes is that they are not incorporated into a useful cooking utensil, It is usually necessary to require a separate temperature probe rather than incorporating the feature into an item having additional utility.

A yet further problem with conventional temperature probes is that they may not display the actual temperature in a suitable manner. Instead, the tendency is to provide LED lights indicating particular temperature range. This minimizes the information available to a user of the utensil.

### OBJECT OF THE INVENTION

It is an object of the present invention to provide a cooking utensil and temperature sensor which overcomes some of the disadvantages of the prior art or at least provides the public with a useful choice.

### SUMMARY OF THE INVENTION

Accordingly, in a first aspect, the invention may broadly be said to consist in a cooking utensil comprising:

at least one elongate member for insertion into an article being cooked;

a temperature sensor on or in said elongate member to determine an internal temperature of said product being cooked;

storage means to store a range of predetermined temperatures;

selection means to allow a user to select a desired temperature or temperature range for different product types and/or degrees of cooking from said storage means,

processing means to receive a signal from said temperature sensor and compare the input from the temperature sensor against the selected desired temperature; and

output means to output a result of the comparison performed by the processing means.

Accordingly, in a second aspect the invention may broadly be said to consist in a cooking utensil comprising:

at least one elongate member for insertion into an article being cooked;

a temperature sensor on or in said elongate member to determine an internal temperature of said product being cooked;

a handle portion; and

display means on or in said handle portion to provide a visual digital readout of the information from said temperature sensor.

### BRIEF DESCRIPTION OF THE DRAWINGS

FIG. 1a shows a plan view of one embodiment of the invention;

FIG. 1b shows a side view of the apparatus of FIG. 1a;

FIG. 2 shows a circuit diagram suitable for a preferred embodiment of the apparatus;

FIG. 3 shows a schematic block diagram for the operations of the circuit diagram of FIG. 2; and

FIGS. 4a, 4b and 4c show cross-sectional, plan and side views of a further embodiment respectively.

### DETAILED DESCRIPTION OF PREFERRED EMBODIMENTS

The present invention provides a cooking utensil 1 which, in this preferred embodiment, is provided in the form of a large fork suitable for carving or as a barbecue fork,

Although the preferred embodiment will be described in relation to such a fork, the invention itself may be applied to individual temperature probes specifically for taking such measurements or, as provided in this preferred embodiment combined with a cooking utensil. Rather than the fork as provided, other cooking utensils such as skewers could be provided with this facility.

The invention includes at least one elongate member for insertion into the product being cooked. This elongate member 2 is provided as one of a pair of tines of a fork in this preferred embodiment. The elongate member is provided to allow insertion of the member into the product as it is generally the internal temperature of the product which will determine the degree to which the product is cooked. This is facilitated by the sharpened ends 4 and 5 of the elongate members 2 and 3 respectively.

A temperature sensor is provided and, in this embodiment, is provided by the tapered tip 4 of the elongate member 2. The temperature sensor need not be provided directly at an end of the elongate member and can be provided part way up the member. The positioning of the temperature sensor is at a convenient point to ensure it can be positioned in a mid-point of the product being cooked. Conveniently, the tip 4 of the barbecue fork is utilized in this instance.

The temperature sensor itself can be any convenient form of sensor providing either a digital or an analogue output According to the range of products which may be desired for measurement with the utensil, the temperature sensor must be sufficiently stable to temperature variations to record temperatures up to or exceeding 180° C.

For subsequent processing of the output of the temperature sensor, it is preferred that the output is provided in a digital form. However, this is not a requirement on the sensor itself as the output from the sensor may undergo an analogue to digital conversion prior to subsequent processing.

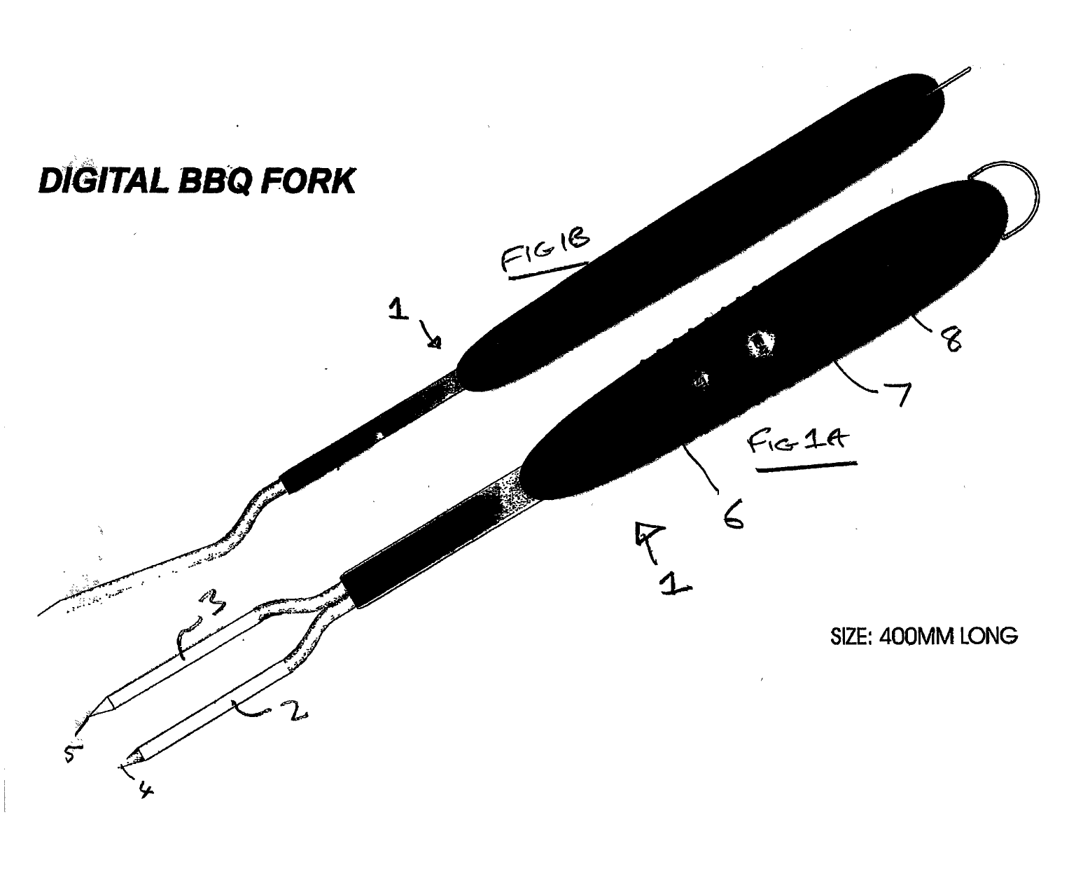

As shown in FIGS. 1a and 1b, the utensil 1 is provided with a handle portion 6 to house a processing means and also provide a user interface 7 for the selective input of information from the user.

Typically the handle portion 6 of this preferred embodiment or elsewhere on the utensil will be provided with a power source to run the processing means described in more detail hereafter.

The temperature sensor 4 is in communication with the processing means housed in the handle 6 by a suitable signal conduit provided within or by the elongate member 2 and into the handle portion 6.

The handle portion 6 is also provided with an output 8 for the display of information resulting from the subsequent processing.

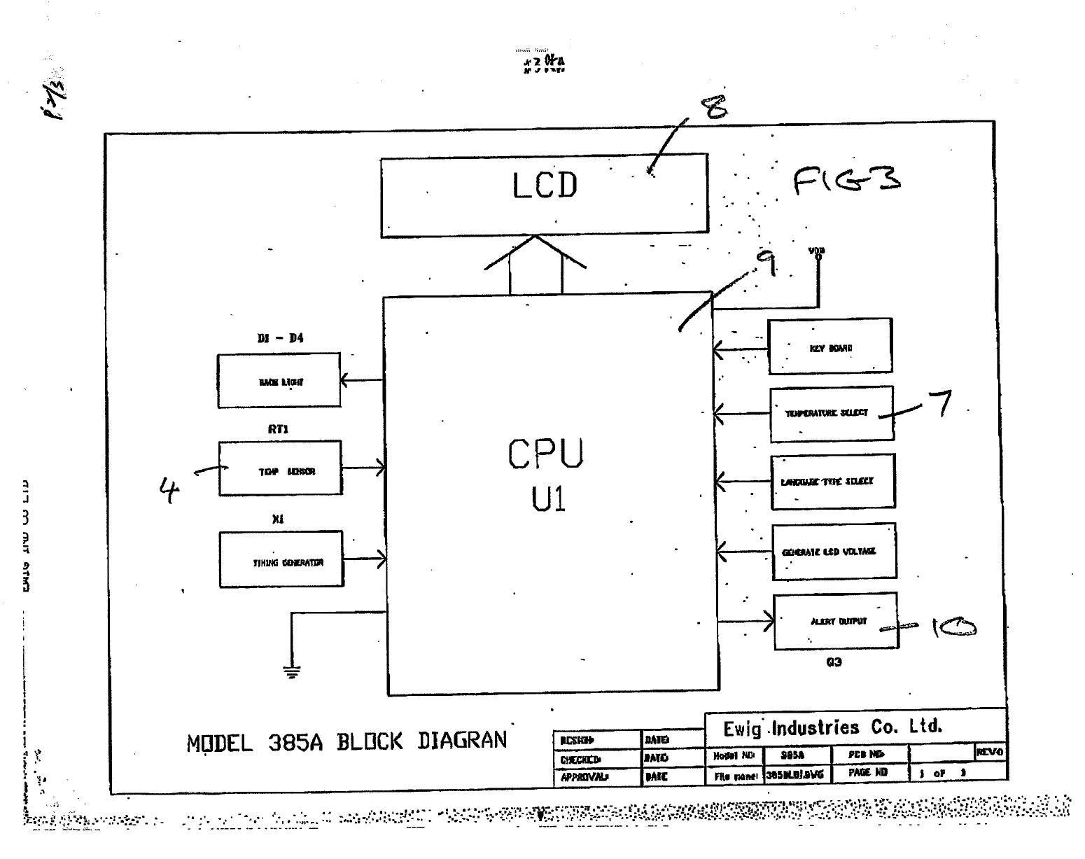

Referring to the block diagram in FIG. 3, it can be seen that the handle 6 can house a processing unit in the form of a CPU 9. This may include a storage means to store a range of values relating to the desired internal temperatures for specific degrees of cooking of, preferably, a variety of different products. It is intended in this present invention that the storage means in or associated with the processor 9 holds the recommended ranges of temperature for different levels of cooking such as well done, medium, medium rare and rare for a range of products such as beef, veal, lamb, pork chicken and turkey. This information on the pre-defined cooking temperatures is available from a variety of sources including published material from the United States Department of Agriculture. For example, in the case of beef, the recommended internal temperature for well-done beef is 170° F. or above. A range of temperatures from 160° F. to 169° F. is suitable for a medium cooking level, 145° F.-159° F. is suitable for medium rare and 140° F.-144° F. is suitable for rate beef. Below 140° F. is undercooked on that scale.

Veal, lamb and pork are likely to be similar settings although it is not usual to have medium rare and rare settings for veal and pork or rare settings for lamb. In contrast, chicken and turkey may be set at 180° F. and above for well done and undercooked below this temperature.

This particular range of values is as provided for this preferred embodiment and as dictated by the USDA. Other ranges may be set for other products or variations on these ranges may be utilized in accordance with other recommendations.

Referring to the diagram of FIG. 3, it can be seen that the processing unit 9 receives input from the temperature sensor 4. As mentioned previously, this may be a converted signal to digital signal more suitable for processing if the sensor itself provides an analogue output. Additionally, the user interface or selection means 7 allows the user to input the degree of desired cooking with the “taste” button and select the meat being cooked with the “meat” button In FIG. 3, is input is a temperature selection according to the range of values that are predetermined and stored in the unit. Additionally a language selection may be utilized if the product is intended for use in bilingual jurisdictions or multiple jurisdictions with such a facility may be useful. Again, this language selection may be defined by the user through a suitable selection.

Once a comparison of the reading from the temperature sensor is made against the desired values, the result may be output to a suitable display such as the LCD 8 as shown. Alternatively or additionally, a separate alert output 10 may be provided if the information from the temperature sensor matches or exceeds the range determined by the user. This additional output 10 may be in any suitable form such as an audible alarm, a visual indicator such as a flashing light or even through vibration with the use of a vibrator motor. It this preferred form either or both of an audible alarm and a flashing backlight on the LCD 8 may be used.

It is intended that in this preferred embodiment, the display 8 will also display the output from the temperature sensor as well as the desired indication on the degree of cooking.

The display 8 of this preferred embodiment is an LCD display providing a digital visual display of the temperature which may be in either degrees Celsius or Fahrenheit as desired. Furthermore, the display 8 also indicates the selections made by the user or can indicate the current level of cooking and the meat selected.

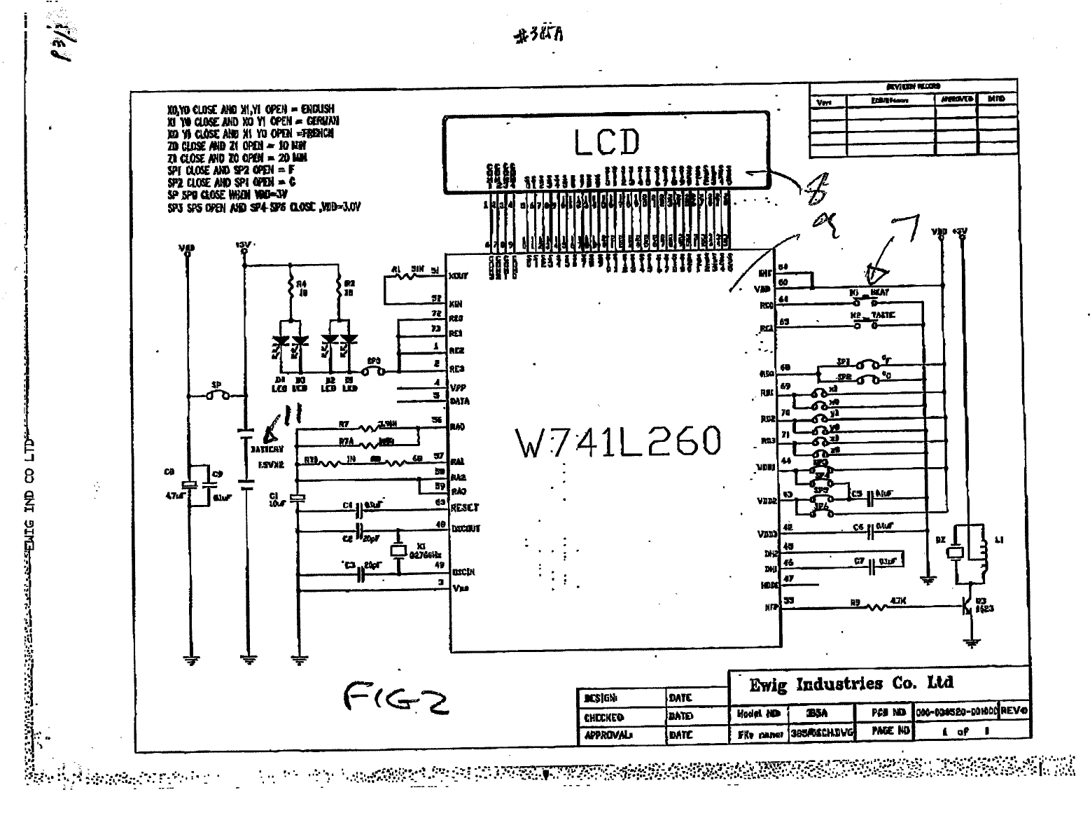

Referring to FIG. 2, the power source 11 in the form of two 1.5v batteries is shown. This provides power to the unit as a whole including the processing means 9. The display means 8 is in direct communication with the processor 9 as are the user interface controls 7.

The timing circuit may also be used in the device to ensure that initial temperature readings are allowed to stabilize. The timing circuit may also be used to allow repeated timed sampling of the output from the temperature sensor to allow averaging of results or even allow the cooking utensil to remain in the product being cooked to provide an alert at a suitable time.

To use the preferred embodiment, it is intended that the tines 2, 3 of the fork 1 are inserted to the mid-point of the thickest part of the meat. Preferably, this should be at least 12 mm into the meat.

Suitable delay may be provided such as 10 to 30 seconds for the temperature sensor to obtain an accurate reading.

The user cam already have selected the product being cooked using a suitable button. In this preferred embodiment, the selection of the meat is obtained by consecutive operations of the “meat” button which will cycle the selection through the various choices until the desired choice is highlighted or displayed on the output 8.

As the temperature with the product increases, the processor may intermittently sample the temperature output and once the predetermined level has been reached, the alert or additional output 10 may operate. Operation of one of the user interface buttons may stop the alert and the tines can be removed.

To assist in power saving, the utensil may manually deactivate after a predetermined period of time during which the temperature sensor indicates a temperature range close to ambient air temperature. Other similar power saving devices may be triggered by a variety of means.

Depending on the cooking situation, it may not be desirable to leave the tines inserted throughout the cooking operation. Although his may be suitable for a barbecue fork, cooking in an oven or similar may require the user to regularly sample the temperatures until the desired range has been reached.

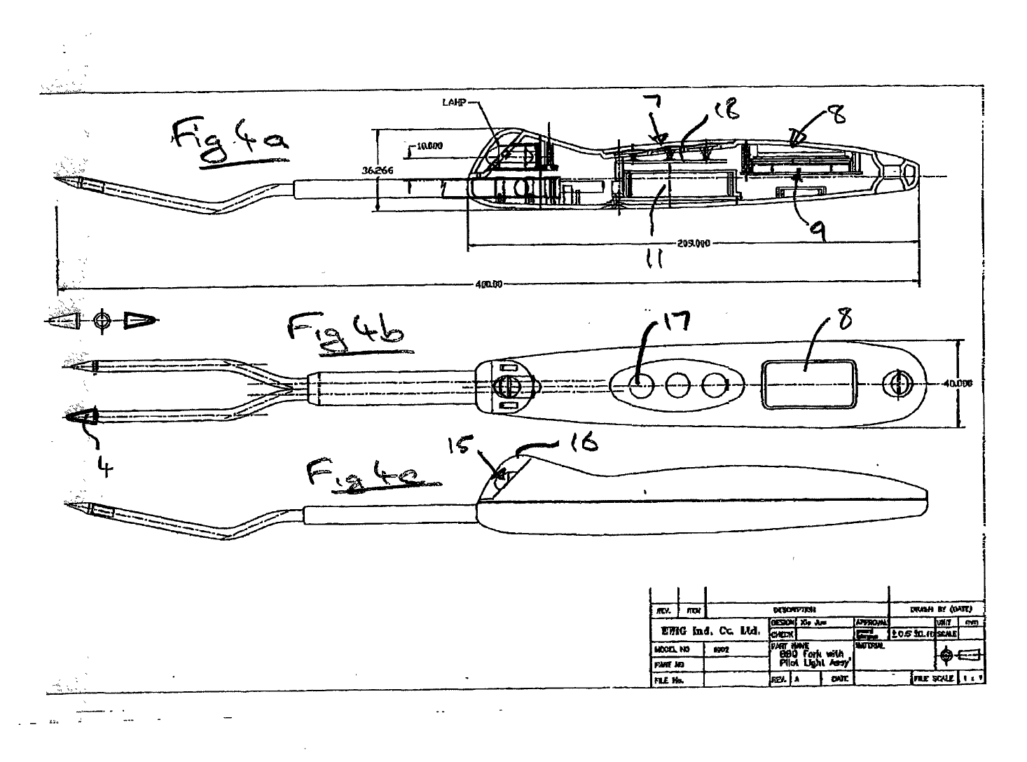

A further embodiment of the invention is shown in FIGS. 4a, 4b and 4c. In general, the embodiment is the same as the previous embodiment although there is an additional pilot light 15 provided beneath substantially transparent cover 16. This pilot light is provided at an end of the handle portion and directed towards the remainder of the utensil to provide some additional lighting towards the tines of the fork, The light 15 may comprise a suitable lamp retained behind a cover 16 which may be removable to allow replacement of the lamp.

The light may be controlled by its own control means in the form of a switch or button 17 on the user interface panel.

As with the previous embodiment, the temperature sensor 4 is at an end of one of the tines of the fork and the cross-sectional view in FIG. 4a shows the battery compartment 11, a control board 18 beneath the buttons or selection means 7, the LCD) display and the processing means may be arranged adjacent any of these such as behind the LCD display 8.

Thus it can be seen that the invention provides a cooking utensil together with a temperature sensor which not only provides a temperature reading but also allows the comparison of that reading with ranges according to different cooking levels and/or different products,

This description is provided to describe preferred embodiments and should not considered limiting to the scope of the invention as claimed. Integers referred to in the singular may include the plural where appropriate. Furthermore, integers may incorporate equivalents where deemed suitable by those skill in the art.

1. A cooking utensil comprising:
at least one elongate member for insertion into an article being cooked;
a temperature sensor on or in said elongate member to determine an internal temperature of said product being cooked;
storage means to store a range of predetermined temperatures;
selection means to allow a user to select a desired temperature or temperature range for different product types and/or degrees of cooking from said storage means;
processing means to receive a signal from said temperature sensor and compare the input from the temperature sensor against the selected desired temperature; and
output means to output a result of the comparison performed by the processing means:

2. A cooking utensil as claimed in claim 1 wherein said elongate member comprises at least one tine of a fork.

3. A cooking utensil as claimed in claim 1 wherein said temperature sensor is positioned at or adjacent an end of said elongate member.

4. A cooking utensil as claimed in claim 1 wherein said storage means, processing means, user interface and output are provided in a handle portion of said utensil.

5. A cooking utensil as claimed in claim 4 wherein said handle portion further includes lighting means directed from said handle portion toward a remainder of said utensil.

6. A cooking utensil as claimed in claim 1 wherein said output means includes a visual display of the temperature.

7. A cooking utensil as claimed in claim 6 wherein said visual display includes information on the selections made through the user interface.

8. A cooking utensil as claimed in claim 6 wherein an additional output is provided once the predetermined level of cooking has been achieved.

9. A cooking utensil as claimed in claim 8 wherein said additional output is provided by at least one of an audible signal, a visual display or vibration of the utensil.

10. A cooking utensil comprising:
at least one elongate member for insertion into an article being cooked;
a temperature sensor on or in said elongate member to determine an internal temperature of said product being cooked;
a handle portion; and
display means on or in said handle portion to provide a visual digital readout of the information from said temperature sensor.

11. A cooking utensil as claimed in claim 10 wherein said utensil comprises a fork.

12. A cooking utensil as claimed in claim 10 when said visual display comprises a liquid crystal display.

13. A cooking utensil as claimed in claim 12 wherein said liquid crystal display also indicates a level of cooking or at least one type of meat.

14. A cooking utensil as claimed in clam 10 who said handle portion further includes lighting means directed from said handle portion towards a remainder of said utensil.
